(19) United States
(12) Patent Application Publication
(10) Pub. No.: US 2013/0102338 A1
(43) Pub. Date: Apr. 25, 2013

(54) Valet parking system and method utilizing wireless text messaging

(71) Applicant: Kenneth J. Lovegreen, Lake Kiowa, TX (US)

(72) Inventor: Kenneth J. Lovegreen, Lake Kiowa, TX (US)

(21) Appl. No.: 13/507,423

(22) Filed: Jun. 27, 2012

Related U.S. Application Data
(60) Provisional application No. 61/627,904, filed on Oct. 20, 2011.

(51) Int. Cl. H04W 4/14

(52) U.S. Cl. 455/466

(57) ABSTRACT

A method and a server for controlling valet parking services. When a guest arrives, a valet employee sends the server a guest arrival message containing a valet ticket number and an associated mobile phone number of the guest. The server sends a welcoming message to the guest with instructions for the guest to simply reply to the welcoming message to request retrieval of the guest's vehicle. Alternatively, the instructions may include a Shortcode number to which the reply text message is to be sent. When the server subsequently receives the reply message from the guest, the server matches the mobile phone number of the guest with the associated valet ticket number, and sends a retrieval message to the valet employee or supervisor instructing that the guest vehicle with the associated valet ticket number be retrieved. The server prevents employee fraud by ensuring ticket numbers are not used more than once.

### CROSS-REFERENCE TO RELATED APPLICATIONS

This application claims the benefit of U.S. Provisional Application No. 61/627,904 filed Oct. 20, 2011, the disclosure of which is incorporated herein by reference in its entirety.

### BACKGROUND

1. Technical Field

This invention relates to valet parking services and, more particularly, to a system and corresponding method for providing valet parking services utilizing wireless text messaging and for reducing employee fraud.

2. Description of Related Art

Valet services traditionally issue paper tickets, each having three detachable sections with a serial number printed on each section. When a guest drops off his car, the valet parking employee gives a first section to the guest, who retains this section for presentation to the valet parking employee upon returning to pick up his car. After parking the car, the employee places a second section of the ticket in the car, typically hung from the rearview mirror, to identify the car when being retrieved. The employee attaches a third section of the ticket to the car keys that the guest leaves with the employee upon dropping off the car so that the keys can be identified from others in the valet key bin.

When the guest returns to pick up his car, the guest presents the first ticket section to the valet parking employee. The employee matches the serial number on the first ticket section to a ticket section attached to a set of car keys in the valet key bin. The employee then takes those keys and retrieves the car having a matching serial number on the ticket section in the car.

At the end of the day, the valet company matches revenue received against the number of tickets utilized.

This process usually works well, but problems can and do occur when using paper tickets. For example, the guest may lose his ticket section. The employee may remember the guest and his car, but if not, a lengthy process may ensue to match the guest to his car and properly verify the guest as the owner of the car.

Tickets also cost the valet company money and have to be transported in sufficient numbers to each valet parking station.

Another disadvantage with paper tickets is that the guest cannot start the process of reclaiming his car until he arrives at the valet station and hands his ticket section to the valet parking employee. The guest must then wait while the employee finds the keys and retrieves the car from a remote location. With the explosion in mobile phone technology, a few vendors have developed a text-based request process that enables the guest to request his car before returning to the valet station. The valet system basically operates the same, but the guest is also given a phone number to which the guest can text a message consisting of his ticket serial number when he wants the valet parking employee to retrieve his car. The phone number is SIM-card inserted in a printer at the valet station, and when the guest sends the text message, the printer receives the message and prints out the ticket number for the employee. The employee then retrieves the guest's car in the traditional manner. In this way, the car may be waiting at the valet station when the guest physically returns.

Although enabling the guest to request the vehicle without being physically present at the valet station, this system still has a number of disadvantages. No confirmation is given to the guest, so he does not know whether he properly keyed in the phone number and the ticket serial number. If he did not, the valet printer will not receive the message or will print out the mistyped ticket number. In either case, the guest will be disappointed when he arrives at the valet station and his car is not ready for him.

Another big problem seen in the valet industry is “ticket scamming” or “re-ticketing”. This occurs when the valet employee reuses a ticket for multiple guests and pockets the money received from subsequent users of the same ticket. Since the valet company matches revenue received against the number of tickets utilized, this extra revenue is not tracked. There is currently no solution to this problem.

### SUMMARY OF THE INVENTION

It can thus be seen there is a need for a valet parking system and method that eliminates the cost and burden of paper tickets, provides convenience to the guest, and eliminates or reduces ticket scamming. The present invention provides such a system and method.

Embodiments of the present disclosure utilize a central database to check-in vehicles and tickets, and allow guests to request their vehicles without knowing a ticket serial number or a phone number for texting their request.

In one embodiment, a method in a server for controlling valet parking services is disclosed. The method includes the steps of receiving at the server, guest arrival information from a valet employee, the guest arrival information including a valet ticket number and an associated mobile phone identifier of a guest to whom the valet ticket number is assigned; sending a welcoming message from the server to the mobile phone of the guest with instructions for the guest to send a reply message to request retrieval of the guest's vehicle; and subsequently receiving at the server, the reply message from the guest, the reply message indicating as a source, the mobile phone identifier of the guest. The method also includes matching by the server, the mobile phone identifier of the guest with the associated valet ticket number; and sending a retrieval message from the server to the valet employee or a valet supervisor instructing that the guest vehicle with the associated valet ticket number be retrieved.

In another embodiment, a server for controlling valet parking services at a valet parking station is disclosed. The server includes a processor coupled to a non-transitory memory that stores computer program instructions. When the processor executes the computer program instructions, the processor causes the server to receive guest arrival information from a valet employee, the guest arrival information containing a valet ticket number and an associated mobile phone identifier of a guest to whom the valet ticket number is assigned; store an association between the valet ticket number and the mobile phone identifier of the guest; and send a welcoming message to the mobile phone of the guest with instructions for the guest to send a reply message to request retrieval of the guest's vehicle. The server is also caused to subsequently receive the reply message from the guest, the reply message indicating as a source, the mobile phone identifier of the guest; match the mobile phone identifier of the guest with the associated valet ticket number; and send a retrieval message to the valet employee or a valet supervisor instructing that the guest vehicle with the associated valet ticket number be retrieved.

In another embodiment, an alternative method in a server for controlling valet parking services is disclosed. The method includes storing in the server, an association between a plurality of valet ticket numbers and a valet parking company, wherein when a guest arrives at the valet parking company, a valet employee provides the guest with one of the plurality of valet ticket numbers and instructions to text the serial number to a given phone number for the server or to a Shortcode carrier for forwarding to the server when the guest wants his vehicle to be retrieved. The method also includes subsequently receiving at the server, a message from the guest containing the valet ticket number provided to the guest by the valet employee; and sending a retrieval message from the server to the valet parking company associated with the received valet ticket number instructing that the guest vehicle with the received valet ticket number be retrieved.

The method may also include the steps of checking an activity log by the server to determine whether the valet ticket number provided to the guest by the valet employee has been used in a previous transaction; and if so, notifying the valet parking company that the valet ticket number has been used more than once.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of an exemplary embodiment of the system of the present invention;

FIG. 2 is a flow chart illustrating the steps of an exemplary embodiment of the method of the present invention;

FIG. 3 is a flow chart illustrating the steps of another exemplary embodiment of the method of the present invention; and

FIG. 4 is a simplified block diagram of an exemplary embodiment of a central server configured to perform the method of the present invention.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components, and circuits have not been described in detail so as not to obscure the present invention. The invention may be implemented in hardware or in a combination of hardware and software. For example, one or more computers or processors may perform the steps of the method of the present invention when executing computer program instructions stored in one or more program memories. Additionally, individual components of the invention may include their own processor and memory for controlling their functions.

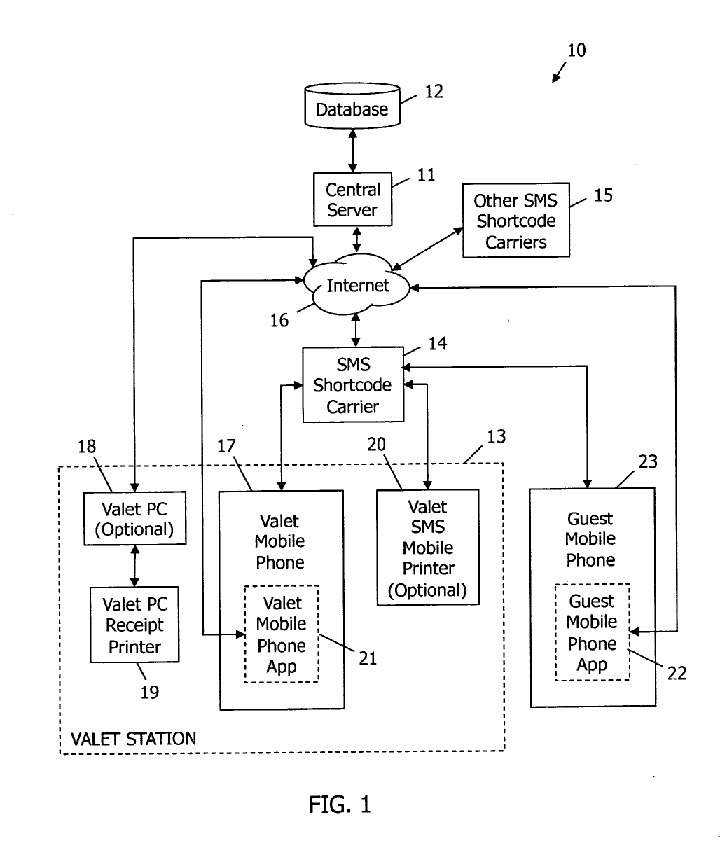

FIG. 1 is a simplified block diagram of an exemplary embodiment of a Ticketless Valet System 10 of the present invention. A Central Server 11 is associated with a database 12. The Central Server and database may be located remotely from one or more valet stations such as valet station 13. The Central Server may utilize an assigned Shortcode, a 5-digit telephone number for sending/receiving text messages. Shortcodes are owned by third-party Short Message System (SMS) Shortcode carriers such as SMS Shortcode carrier 14 and other Shortcode carriers 15, whose servers may interface with the Central Server 11 over a data network such as the Internet 16. In an embodiment of the present invention, all valet systems utilize the same Shortcode.

The valet station 13 may include a valet mobile phone 17, which in one embodiment, may be a simple mobile phone with text messaging capabilities. Optionally, the valet station may also include a valet PC 18 and a valet PC receipt printer 19. Additional optional equipment may include a valet SMS mobile printer 20.

The Central Server 11 may also communicate over the Internet 16 with mobile applications (mobile apps) developed for this solution. One such application is an optional valet mobile phone application 21. Another is an optional guest mobile phone application 22 stored on a guest mobile phone 23.

### Embodiment #1

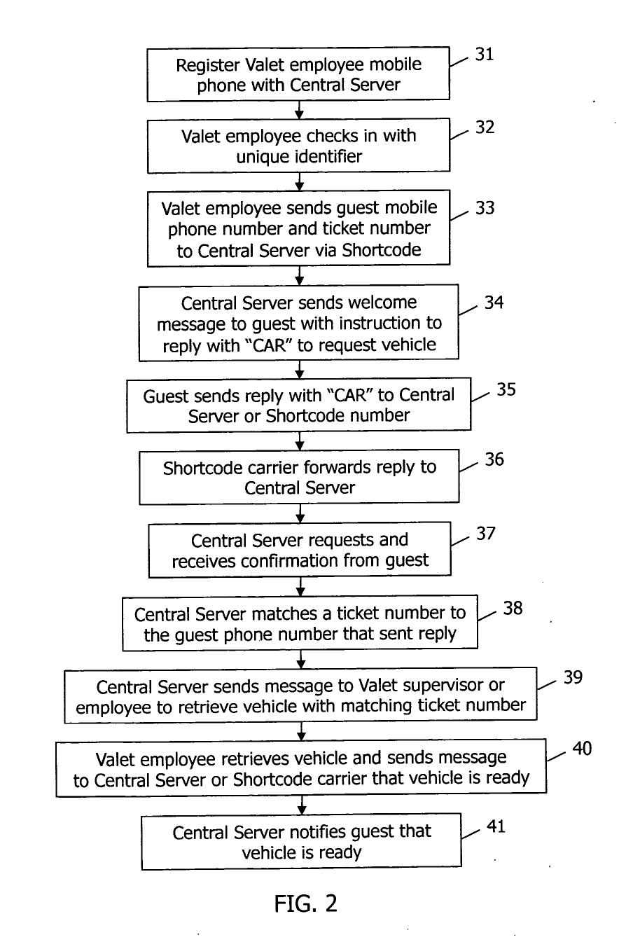

FIG. 2 is a flow chart illustrating the steps of an exemplary embodiment of the method of the present invention. In this embodiment, the only equipment needed at the valet station 13 is the valet mobile phone 17 (with either the valet mobile phone application 21 or text messaging capabilities) for use by the valet parking employee. It is assumed for this example that the guest has a simple mobile phone with text messaging capabilities.

At step 31, the employee's phone is registered with the Central Server 11 as belonging to the valet company. At step 32, the valet parking employee uses his/her mobile phone 17 to check in to work. The employee may do this by sending a message utilizing the valet mobile phone application 21 via the Internet, or by sending a text message such as “IN” together with a unique identifier such as a PIN number to the company's Shortcode from a company mobile phone. The unique PIN number matches the employee's record in the Central Server database 12.

In one embodiment, messages get from the valet mobile phone 17 to one of the SMS Shortcode Carriers through a serving Base Station (BS) and to a serving Mobile Switching Center (MSC) where the Shortcode is recognized as belonging to a particular SMS Shortcode Carrier, and the MSC routes the message to that carrier's SMS Message Center. For simplicity, these known network nodes are not shown in FIG. 2. The SMS Message Center then connects via a packet-switched link (wired or wireless) through the Internet 16 to the Central Server 11 and central database 12.

At step 33, upon arrival of a guest, the valet parking employee asks the guest for his/her mobile phone number. The employee sends the guest's mobile phone number along with a valet ticket number for the car as a guest arrival message to the company Shortcode or to the Central Server 11 if using the valet mobile phone application 21. For example “2145551212 9876” may be sent for a phone number of 2145551212 and a ticket number of 9876. Optionally, the guest may be given a ticket, which may be paper or reusable plastic, but this is not required. In an alternative embodiment, the guest's mobile phone number itself or a portion thereof may be used as the ticket number.

Upon receiving this information, the third party server (SMS Shortcode Carrier) passes the arrival text message to the Central Server, which matches the ticket number to the phone number for future use. The Central Server also ensures that the valet ticket number has not been previously used, thus preventing employee ticket scamming.

At step 34, the Central Server may send the guest a welcoming message (via text or the Internet and the guest mobile phone application 22) welcoming him/her to the valet company. The welcoming message may show the ticket number along with an instruction to reply to this message with “CAR” (or some other suitable word) to request their vehicle. For example the welcoming message may read, “Thanks for using ABC Valet. Please reply to this message with CAR when you wish to retrieve your vehicle.”

At a later time, when the guest desires to retrieve his/her vehicle, the guest merely replies to the welcoming message with “CAR” at step 35. The reply message, if a text message, is sent to the Shortcode, and the Shortcode carrier passes the reply message to the Central Server 11 at step 36. At step 37, the Central Server may respond by sending back a confirmation message (to avoid mis-types, etc). For example, the confirmation message may state that the request to retrieve the guest's vehicle has been received, or may request a further confirmation from the guest. For example, the confirmation message may state, “You have requested your car. Reply Y to confirm.”

Upon confirming the proper response, the Central Server 11 looks up the phone number that sent the request and matches it to the ticket number at step 38. At step 39, the Central Server then initiates a retrieval message to the valet supervisor or the valet parking employee (via text or the Internet and the valet mobile phone application 21) to retrieve the vehicle with the matching ticket number. The retrieval message may state, for example, “Retrieve Ticket #9876”. The Central Server may also send a message to the guest stating, “Your car has been requested”. This message may optionally include a time estimate for when the car will be ready. For example, “Your car will be ready in 5 minutes.” This time period may be set to a default value such as five minutes and may be reset to a different value by the valet supervisor depending on current conditions at the valet station.

Once the car is retrieved and waiting for the guest, the valet parking employee sends a ready message such as “{Ticket Number} OK” to the Central Server 11 or Shortcode carrier 14 at step 40. At step 41, the Central Server receives this information and may notify the guest with a message such as, “Your car is now waiting at the valet station”.

At this time or soon thereafter, the Central Server may also initiate a message to the guest requesting information for a satisfaction survey. For example, the Central Server may text, “Thanks for using ABC Valet. How was our service?” or other suitable message.

The Central Server 11 may also create a log of all of the day's activity. A valet owner can access this log to see various statistics such as the number of cars processed on given days, the number of cars currently checked in, pending requests, survey results, or other management information.

An online computer such as the valet PC 18 may also be used at the valet station 13 (if electrical power and a wired or wireless network connection are available). This enables the valet supervisor to see all cars checked in and any requests in real time.

If the valet company charges by the amount of time a car is parked, the valet (or cashier) may send a text to the Shortcode such as “TT 9876” when the guest requests his car. The Central Server returns the Total Time since receiving the arrival text message so that charges can be calculated. Alternatively, the Central Server may make the calculation and return the charges to the valet station.

For those guests without mobile phones (or foreigners without Shortcode access), a paper ticket can still be used.

The present invention may be implemented as either Free-to-Valet or Free-to-Guest services. A Free-to-Valet service charges the guest's mobile phone for a transaction. A Free-to-Guest service charges a monthly fee to the valet company based on the number of cars served through the system.

In one embodiment, the valet mobile phone 17 includes the valet mobile phone application 21, which provides a data service in lieu of the SMS service, while the guest mobile phone does not have the guest mobile phone application 22 and thus is limited to SMS text messaging. The valet mobile phone application may also implement a method to accept credit cards so the guest can “swipe and go”.

### Embodiment #2

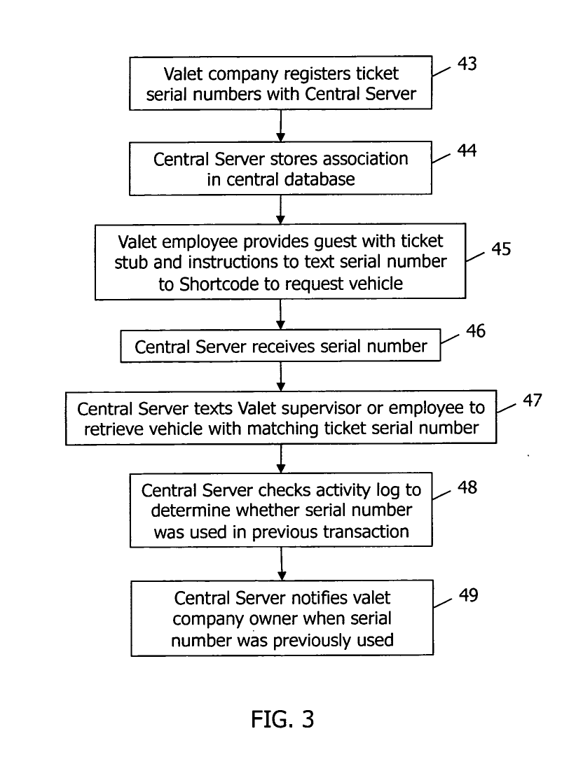

FIG. 3 is a flow chart illustrating the steps of another exemplary embodiment of the method of the present invention. This embodiment utilizes paper tickets with serial numbers. At step 43, a valet company buys and registers the serial numbers of their valet tickets with the Central Server 11. At step 44, the Central Server stores an association between the valet company and its serial numbers in the central database 12. At step 45, the valet employee provides the guest with a ticket with a stub stating, for example, “When you want your vehicle, please text 123456789 to Shortcode UVXYZ”, where 123456789 is an exemplary serial number. The Shortcode carrier 14 operates the same as in the first embodiment and forwards the serial number to the Central Server 11 at step 46. The Central Server looks up the serial number and knows the serial number was assigned to the associated valet company. At step 47, the Central Server then initiates a retrieval text message to the valet supervisor or the valet parking employee to retrieve the vehicle with the matching ticket serial number. At step 48, the Central Server may also check the activity log to determine whether the serial number has already been used in a previous transaction. If so, the Central Server may flag the transaction as a duplicate and at step 49 may notify the valet company owner of a possible ticket-scamming event by an employee.

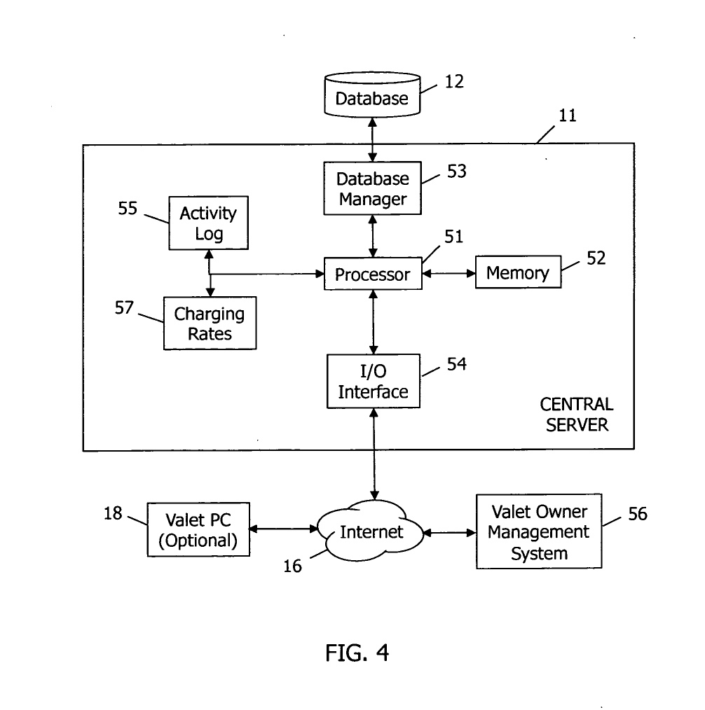

FIG. 4 is a simplified block diagram of a Central Server 11 configured to perform the method of the present invention. Operation of the Central Server may be controlled by hardware or a combination of hardware and software. In the illustrated embodiment, operation of the Central Server is controlled by a processor 51 executing computer program instructions stored on a non-transitory memory 52. The processor controls a database manager 53 to read and write information to the database 12. The processor also controls an input/output (I/O) interface 54, which enables the Central Server to communicate over the Internet 16 with equipment at valet stations and with mobile phone applications.

The processor 51 may also log and timestamp each of the day's transactions in an activity log 55. Through a valet owner management system 56, a valet owner can access the activity log to see various statistics such as the number of cars processed on given days, the number of cars currently checked in, pending requests, survey results, or other management information. The processor also accesses the activity log when checking for ticket-scamming transactions to determine whether a given serial number has already been used in a previous transaction. If so, the Central Server may flag the transaction as a duplicate and notify the valet company owner of a possible ticket scamming event through the valet owner management system.

As noted above, if the valet company charges by the amount of time a car is parked, the valet (or cashier) may send a text to the Shortcode such as “TT 9876” when the guest requests his car. The Central Server 11 checks the activity log 55, and returns the Total Time since receiving the arrival text message so that charges can be calculated. Alternatively, the Central Server may also access a charging rates table 57 and make the calculation and return the charges to the valet station.

In another embodiment, the system may offer location-based advertising. Since the exact location of the guest is known when they check-in, the Central Server 11 may send appropriate advertising texts to the guest for retailers in the area. For example, if the guest checks in at a mall, the system may send, in addition to the welcome message, but also text coupon(s) for nearby stores.

It is thus believed that the operation and construction of the present invention will be apparent from the foregoing description. While the system and apparatus shown and described has been characterized as being preferred, it will be readily apparent that various changes and modifications could be made therein without departing from the scope of the invention as defined in the following claims.

What is claimed is:

1. A method in a server for controlling valet parking services, the method comprising the steps of:
receiving at the server, guest arrival information from a valet employee, the guest arrival information including a valet ticket number and an associated mobile phone identifier of a guest to whom the valet ticket number is assigned;
sending a welcoming message from the server to the mobile phone of the guest with instructions for the guest to send a reply message to request retrieval of the guest's vehicle;
subsequently receiving at the server, the reply message from the guest, the reply message indicating as a source, the mobile phone identifier of the guest;
matching by the server, the mobile phone identifier of the guest with the associated valet ticket number; and
sending a retrieval message from the server to the valet employee or a valet supervisor instructing that the guest vehicle with the associated valet ticket number be retrieved.

2. The method according to claim 1, wherein the step of receiving the guest arrival information at the server includes receiving the guest arrival information from the valet employee via a valet mobile phone application and the Internet.

3. The method according to claim 1, wherein the step of receiving the guest arrival information at the server includes receiving the guest arrival information via a Short Message Service (SMS) text message sent from a mobile phone registered with the server and associated with the valet employee.

4. The method according to claim 1, wherein the mobile phone identifier of the guest is an Internet Protocol (IP) address, and the step of sending a welcoming message from the server to the mobile phone of the guest includes sending the welcoming message to the guest's mobile phone via the Internet.

5. The method according to claim 1, wherein the mobile phone identifier of the guest is a telephone number, and the step of sending a welcoming message from the server to the mobile phone of the guest includes sending the welcoming message to the mobile phone number of the guest via a Short Message Service (SMS) text message.

6. The method according to claim 5, wherein the step of sending the welcoming message to the mobile phone number of the guest includes sending instructions for the guest to send a reply text message to a Shortcode number to request retrieval of the guest's vehicle, wherein a Shortcode carrier forwards the guest's reply text message to the server.

7. The method according to claim 1, further comprising, after receiving the reply message from the guest, the step of sending a confirmation message from the server to the mobile phone of the guest confirming that the request to retrieve the guest's vehicle has been received.

8. The method according to claim 1, further comprising the steps of:
receiving at the server, a ready message from the valet employee indicating that the guest vehicle with the associated valet ticket number has been retrieved; and
sending a notification message from the server to the mobile phone of the guest indicating that the guest's vehicle has been retrieved.

9. The method according to claim 1, further comprising, after receiving the guest arrival information from the valet employee, the step of ensuring by the server that the valet ticket number has not been previously used.

10. The method according to claim 1, further comprising, sending from the server to the mobile phone of the guest, an advertising text message or discount coupon for a retailer at a location near the guest's location.

11. A server for controlling valet parking services at a valet parking station, wherein the server includes a processor coupled to a non-transitory memory that stores computer program instructions, wherein when the processor executes the computer program instructions, the processor causes the server to:
receive guest arrival information from a valet employee, the guest arrival information containing a valet ticket number and an associated mobile phone identifier of a guest to whom the valet ticket number is assigned;
store an association between the valet ticket number and the mobile phone identifier of the guest;
send a welcoming message to the mobile phone of the guest with instructions for the guest to send a reply message to request retrieval of the guest's vehicle;
subsequently receive the reply message from the guest, the reply message indicating as a source, the mobile phone identifier of the guest;
match the mobile phone identifier of the guest with the associated valet ticket number; and
send a retrieval message to the valet employee or a valet supervisor instructing that the guest vehicle with the associated valet ticket number be retrieved.

12. The server according to claim 11, wherein after receiving the guest arrival information from the employee, the server is configured to ensure the valet ticket number has not been previously used.

13. The server according to claim 11, wherein after receiving the reply message from the guest, the server is configured to send a confirmation message to the mobile phone identifier of the guest confirming that the request to retrieve the guest's vehicle has been received.

14. The server according to claim 11, wherein after the server sends the retrieval message to the valet employee or the valet supervisor, the server is configured to:
receive a ready message from the valet employee indicating that the guest vehicle with the associated valet ticket number has been retrieved; and
send a notification message to the mobile phone identifier of the guest indicating that the guest's vehicle has been retrieved.

15. The server according to claim 11, wherein the welcoming message sent to the mobile phone identifier of the guest includes a destination to which the reply message is to be sent to request retrieval of the guest's vehicle.

16. The server according to claim 11, wherein the destination to which the reply message is to be sent is a Shortcode number, wherein the server receives the guest's reply message from a Shortcode carrier.

17. A method in a server for controlling valet parking services, the method comprising the steps of:
storing in the server, an association between a plurality of valet ticket numbers and a valet parking company, wherein when a guest arrives at the valet parking company, a valet employee provides the guest with one of the plurality of valet ticket numbers and instructions to text the serial number to a given phone number for the server or to a Shortcode carrier for forwarding to the server when the guest wants his vehicle to be retrieved;
subsequently receiving at the server, a message from the guest containing the valet ticket number provided to the guest by the valet employee; and
sending a retrieval message from the server to the valet parking company associated with the received valet ticket number instructing that the guest vehicle with the received valet ticket number be retrieved.

18. The method according to claim 17, further comprising maintaining by the server, an activity log indicating which of the plurality of valet ticket numbers are used in each parking transaction.

19. The method according to claim 18, further comprising the steps of:
checking the activity log by the server to determine whether the valet ticket number provided to the guest by the valet employee has been used in a previous transaction; and
when the valet ticket number provided to the guest by the valet employee has been used in a previous transaction, notifying the valet parking company that the valet ticket number has been used more than once.

20. The method according to claim 17, further comprising, after receiving the message from the guest, the step of sending a confirmation message from the server to the guest confirming that the request to retrieve the guest's vehicle has been received.

21. The method according to claim 17, further comprising the steps of:
receiving at the server, a ready message from the valet employee indicating that the guest vehicle with the associated valet ticket number has been retrieved; and
sending a notification message from the server to the guest indicating that the guest's vehicle has been retrieved.

22. A method in a server for controlling valet parking services, the method comprising the steps of:
receiving at the server, guest arrival information from a valet employee, the guest arrival information including a mobile phone identifier of a guest;
sending a welcoming message from the server to the mobile phone of the guest with instructions for the guest to send a reply message to request retrieval of the guest's vehicle;
subsequently receiving at the server, the reply message from the guest, the reply message indicating as a source, the mobile phone identifier of the guest; and
sending a retrieval message from the server to the valet employee or a valet supervisor instructing that the guest vehicle associated with the mobile phone identifier be retrieved.
